(19) United States
(12) Patent Application Publication
(10) Pub. No.: US 2015/0356865 A1
(43) Pub. Date: Dec. 10, 2015

(54) APPARATUS AND METHOD FOR ALARM PANEL WIFI ALARM AUDIO VERIFICATION CONNECTIVITY TEST

(71) Applicant: Honeywell International Inc., Morristown, NJ (US)

(72) Inventors: Chad Churilla, Nesconset, NY (US); Michael Everald Barrett, Freeport, NY (US); Raymond J. Jordan, Holtsville, NY (US); Eliran Noach, Roslyn Heights, NY (US)

(21) Appl. No.: 14/319,375

(22) Filed: Jun. 30, 2014

Related U.S. Application Data
(60) Provisional application No. 62/008,284, filed on Jun. 5, 2014.

(51) Int. Cl. G08B 29/14

(52) U.S. Cl. CPC G08B 29/14

(57) ABSTRACT

A system and method which provide alarm audio verification testing in connection with a regional monitoring system operate in parallel with a local system control panel, or unit. The testing capability functions in a standalone mode relative to the monitoring system, and, can implement a test without causing a false alarm detectable by the panel.

### CROSS-REFERENCE TO RELATED APPLICATION

This application claims the benefit of the filing date of U.S. Provisional Application Ser. No. 62/008,284 filed Jun. 5, 2014, entitled, “Apparatus and Method for Alarm Panel WIFI Alarm Audio Verification Connectivity Test”. The '284 application is hereby incorporated herein by reference.

### FIELD

The application pertains to systems and methods of conducting alarm audio verification tests. More particularly, the application pertains to such systems and methods which operate in parallel with local monitoring system control units, or panels and which do not cause alarm conditions.

### BACKGROUND

It is known to use an alarm forwarding network to provide verbal communications between a regional monitoring system and a displaced central monitoring station. Such networks, for example, the ALARMNET alarm forwarding system, can include a server to implement wireless verbal communications via the Internet. One such system is disclosed and described in U.S. Pat. No. 8,565,125 B2 entitled Services Based Two Way Voice Service Recoding and Logging, which issued Oct. 22, 2013 and is assigned to the assignee hereof. The '125 Patent is hereby incorporated by reference herein.

Alarm systems with a WIFI pathway are known to utilize SIP and STUN functionality, discussed below, for alarm audio verification (AAV). Session Initiation Protocol (SIP) is an internet telephony control protocol. Session Traversal Utilities for Nat (STUN) enables an end host to discover its public IP address. Real-time Transport Protocol (RTP) is a standardized protocol for transmitting and receiving audio data over the internet.

However, it is unknown at install time whether the panel owner possesses a compatible network topology or the bandwidth requirements necessary to perform AAV. Previously, to verify the compatibility of the panel owner's network topology and to verify the necessary bandwidth, it was required that an owner or installer contact a central station and coordinate a live panic alarm such that the police would not be dispatched if the call were to fail. Furthermore, if the user moves their panel from one location to another location, or changes their network hardware or provider, they would have to repeat these steps each time.

With respect to the above noted problems, testing AAV puts a timely and difficult burden upon installers as well as central stations since it requires installers to be in constant coordination with their central stations so that upon creating an AAV condition, if the call were to fail or be of inadequate quality to deem as a false alarm, police would be dispatched in error.

SIP and RTP, by themselves, cannot work within or behind certain network environments, specifically behind some Network Address Translation (NAT) devices. To combat that insufficiency, Session Traversal Utilities for NAT (STUN) was developed. However, behind certain network environments, STUN is unable to perform its duties thereby rendering SIP or RTP inoperative. In other words: SIP and RTP are generally contingent upon STUN and STUN may fail within certain network topologies, thereby contributing to the above problem.

Given the nature of AAV, it is important that AAV meet or exceed a certain standard of quality. Conversely, the quality of SIP and RTP is subjective and many of the elements contributing to their quality are unknown to end users and alarm system installers before use. This makes it difficult to predict the quality or outcome of SIP or RTP beforehand making it difficult to predict the quality of AAV before using it.

### BRIEF DESCRIPTION OF THE DRAWINGS

FIG. 1 illustrates a block diagram of a system in accordance herewith;

FIG. 2 is a flow diagram illustrating aspects of a method in accordance herewith;

FIG. 3 illustrates additional aspects of the system of FIG. 1;

FIG. 4 is a flow diagram which illustrates aspects of an embodiment of a method in accordance herewith; and

FIG. 5 is a flow diagram that illustrates additional aspects of an embodiment in accordance herewith.

### DETAILED DESCRIPTION

While disclosed embodiments can take many different forms, specific embodiments thereof are shown in the drawings and will be described herein in detail with the understanding that the present disclosure is to be considered as an exemplification of the principles thereof as well as the best mode of practicing same, and is not intended to limit the application or claims to the specific embodiment illustrated.

An alarm audio verification system and method are described subsequently, in conjunction with a high speed internet connection, using SIP, RTP, and STUN.

In one aspect, an alarm system in accordance herewith provides a WIFI alarm audio verification test. This test will enable a panel owner to initiate a test process. This can be by pressing a button, touching a screen or making an oral request, without limitation. This request will connect a call to an alarm forwarding network, for example the ALARMNET network.

The user is able to listen to a phrase, record a phrase, and playback their recording, to verify both that the call was connected and was of acceptable quality. This is all done without causing an alarm condition, thereby obviating the need for coordination with a monitoring, or, central station. It can be done at any time, and as such facilitates easy future testing as conditions change, as described earlier.

The alarm system WIFI AAV test capability has been designed such that it can function in a standalone mode relative to the security system. Normally, when the WIFI AAV test is performed, the information needed for the call is provided with the alarm acknowledgment. However, because the WIFI AAV test capability is implemented as a standalone, another mechanism has been provided that dials a special phone number and contacts a special voip server ip coupled to an input port. As a result, there's no need to create an alarm to start the call.

Because this phone number, ip, and port have been reserved for testing purposes only, an automated response will be played. Ten seconds of audio can then be recorded, and, that ten seconds of audio will be replayed to help verify call quality. While this process is being carried out, the panel can continue to function normally, without compromising the integrity or functionality of the security system.

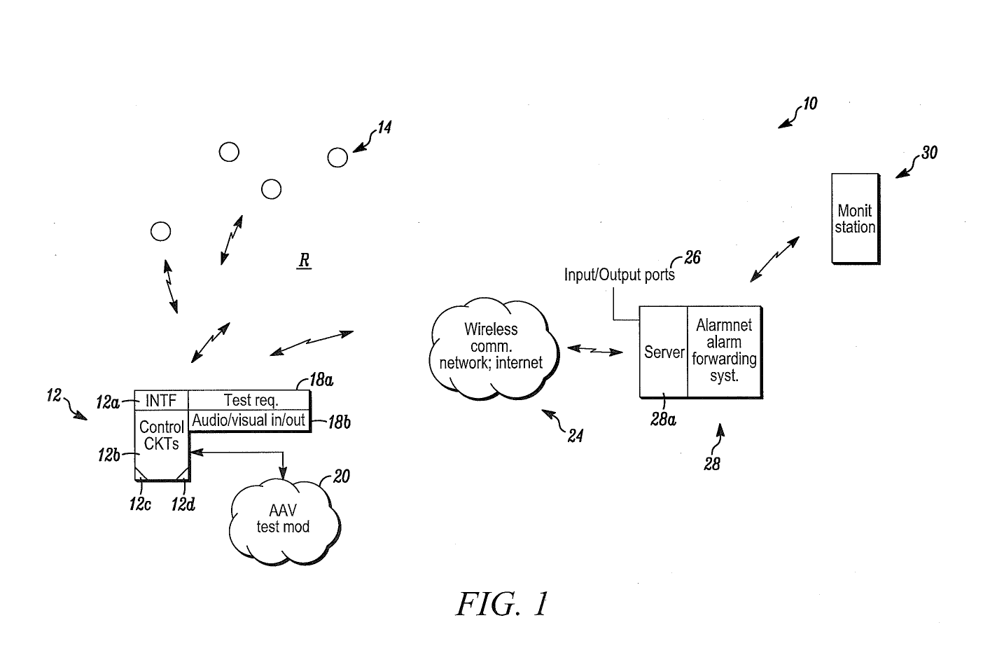

FIG. 1 illustrates a system 10 in accordance herewith. In system 10, a control unit 12 and a plurality of condition detectors 14 monitor a region R. Sensors 14 can include, for example, motion detectors, glass break detectors, smoke fire, or gas detectors all without limitation. Such detectors can be in wired or wireless communications with the control unit, or panel, 12.

Control unit 12 can include a wired and/or wireless interface 12a, and control circuits 12b. Circuits 12b can be implemented, at least in part by a programmable processor 12c and associated, executable control instructions, or software, executable by the processor 12c.

Control unit 12 could also include a test request button, touch screen or audible input device such as illustrated at 18a. An audio/visual input/output device or unit 18b can receive audio inputs from a tester, and output audio, or visual feedback as at 18b.

An AAV test module 20 can be associated with unit 12. The module 20 can be an integral part of the unit 12, or can be an add-on which is coupled to the unit 12 all without departing from the spirit and scope hereof.

A tester, or installer, can initiate an AAV test via input device 18a. In response thereto test module 20 communicates wirelessly via a wireless communication network, such as the Internet, 24 with multiple test and communications ports 26, at a predetermined address, phone number or URL without limitation. The ports 26 are coupled to a displaced server of an alarm forwarding network 28, for example, the ALARMNET alarm forwarding system. The forwarding system communicates with a displaced monitoring station 30. The monitoring station 30 can receive alarm indicating messages from the forwarding system 28 directly, or, via the Internet 24.

In response to an AAV request received at one of the test ports 26, the system 28, via server 28a, can transmit a pre-established confirmatory message which is then presented visually or audibly at output device 18b to confirm for the tester that the requested test is underway.

The tester can then input a verbal message at input/output 18b. This message is transmitted via the network 24 to one of the test ports 26 where it is returned, via server 28a, to the input/output unit 18b to be audibly or visually presented to the tester. If an audible output, the tester can evaluate the quality of the audio and confirm that the communications link is active and operational while the control unit 12 continues to function independently and to carry out it's monitoring functions.

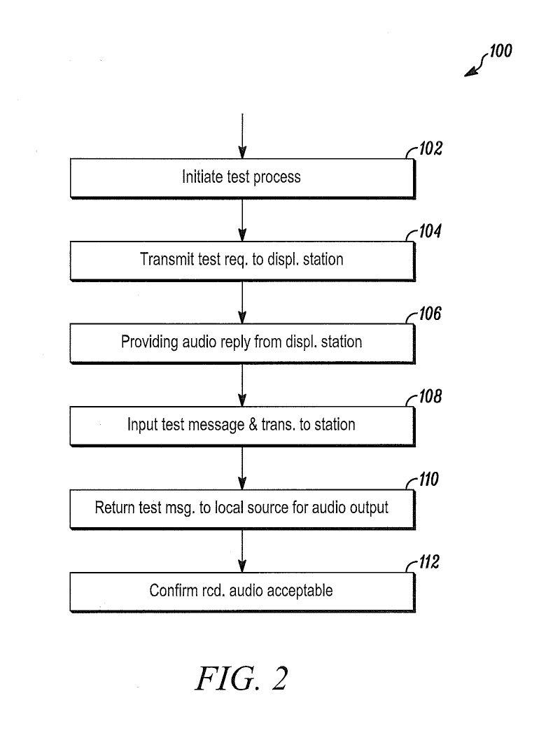

An implementation process 100, is illustrated in FIG. 2. An AAV test process is initiated, as at 102, via the test request device 18a. The test request is wirelessly transmitted to a displaced monitoring station 28, as at 104.

The system 28 transmits a pre-established, or pre-stored audio or visual reply, as at 106, to the output device 18b. The tester can then input a test message, at unit 18b, which is transmitted to the monitoring station 28, as at 108.

The test message is then returned by the server 28a, via network 24 to the output device 18b where the tester can evaluate the quality of the audio connection, as at 110. The test could if desired confirm receipt of the returned audio message and optionally indicate that the audio connection is acceptable, as at 112.

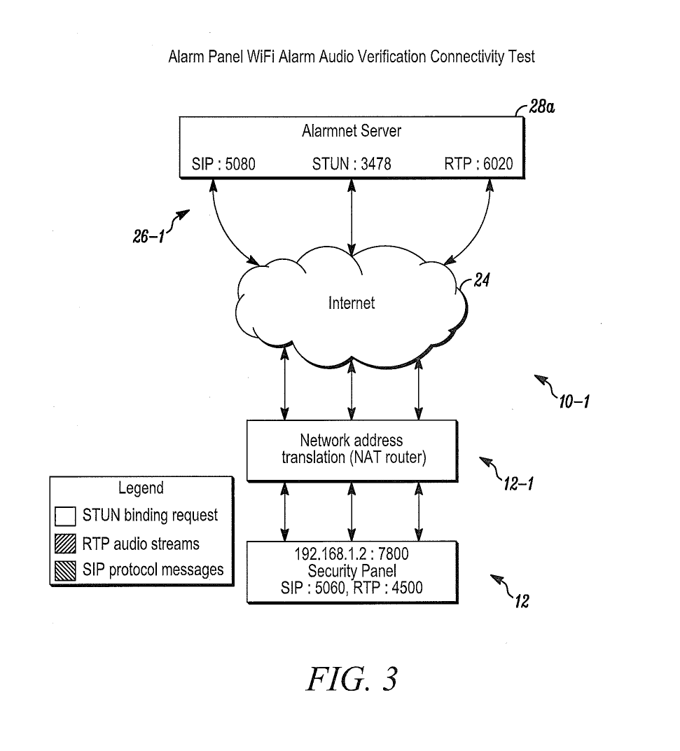

FIG. 3 illustrates details of a system 10-1 in accordance herewith. In FIG. 3, control panel 12 communicates via the Internet 24 with the ALARMNET network server 28a via multiple bidirectional ports 26-1 to implement the above processing, illustrated in FIG. 2.

As will be understood by those of skill in the art, an address translation function can be provided by a NAT router 12-1. Three ports are provided at server 28a, namely, 5080, 3478 and 6020 for SIP, STUN and RTP communications.

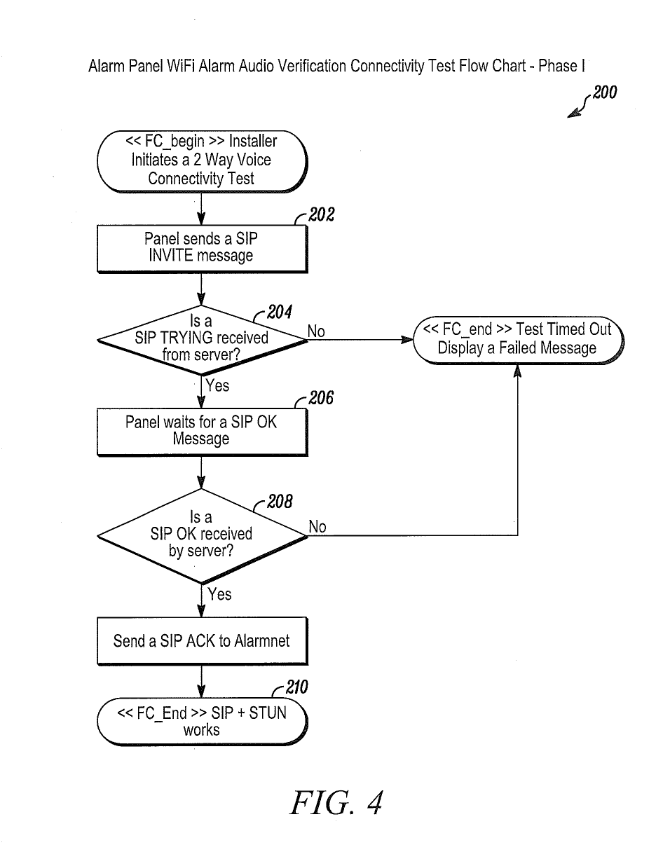

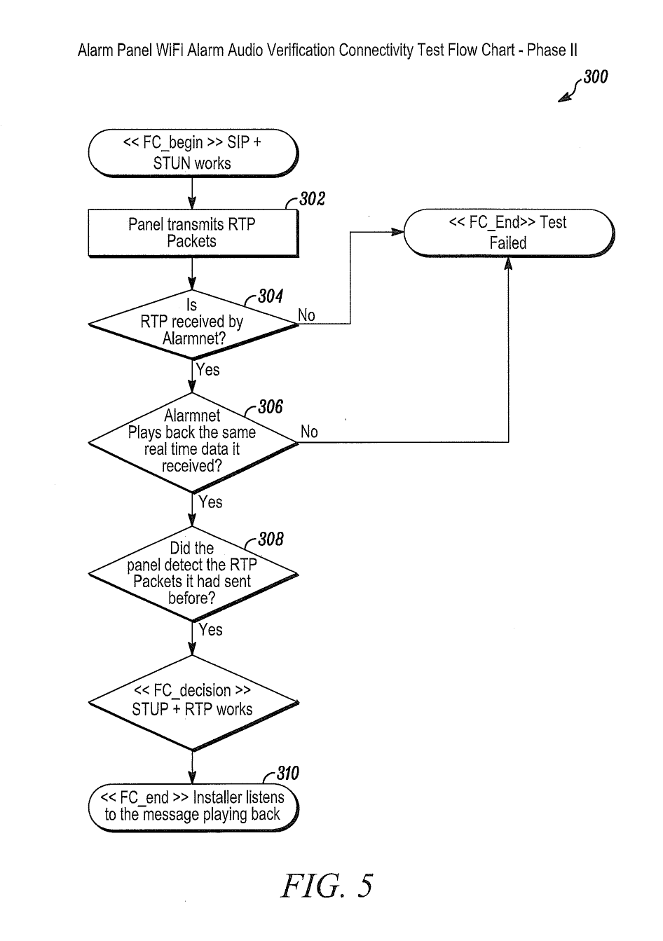

FIGS. 4, 5 illustrate additional processing details. In FIG. 4, in process 200, once a Voice Connectivity Test is initiated, SIP provides signaling and call set up via port 5080. A SIP INVITE message is forwarded to port 5080 as at 202. If a SIP TRYING code is received from the ALARMNET server, as at 204, the panel 12 waits for a SIP OK message as at 206. If a SIP OK is received by the server as at 208, a SIP ACK is sent to the ALARMNET server, as at 210.

FIG. 5 illustrates aspects of process 300 which takes place in response to a successful process 200, described above. Message packets are transmitted, as at 302, to the ALARMNET server via port 6020. Where the transmission is successful, as at 304, the ALARMNET server plays back the received real time data via port 6020 as at 306.

If the panel 12 detects the same packets as it had sent before, as at 308, the message is audibly played for the installer, as at 310, who can evaluate the quality and acceptability thereof.

From the foregoing, it will be observed that numerous variations and modifications may be effected without departing from the spirit and scope hereof. It is to be understood that no limitation with respect to the specific apparatus illustrated herein is intended or should be inferred. It is, of course, intended to cover by the appended claims all such modifications as fall within the scope of the claims.

Further, logic flows depicted in the figures do not require the particular order shown, or sequential order, to achieve desirable results. Other steps may be provided, or steps may be eliminated, from the described flows, and other components may be add to, or removed from the described embodiments.

1. An apparatus comprising:
a monitoring system control device coupled to a plurality of condition monitoring sensors; and
a network enabled alarm audio verification test unit, associated with the control device, but operating independently thereof, to wirelessly initiate communications with a displaced alarm forwarding system to initiate at least a two way audio test.

2. An apparatus as in claim 1 where the test unit communicates wirelessly via the network, with at least one test port of the alarm forwarding system.

3. An apparatus as in claim 2 where the alarm forwarding system transmits a predetermined audio response to the control device which in turn plays that response locally.

4. An apparatus as in claim 3 where the test unit transmits a locally received audio phrase to the alarm forwarding system.

5. An apparatus as in claim 4 where the unit receives the phrase from the alarm forwarding system and presents it locally and audibly apart from functioning of the monitoring system control device.

6. An apparatus as in claim 5 where the network comprises an internet.

7. An apparatus as in claim 2 where the alarm forwarding system includes a signaling and call setup port, and a real-time audio streaming port.

8. An apparatus as in claim 7 including an address translation router located between the control device and the network.

9. An apparatus as in claim 8 where the alarm forwarding system includes a STUN server and an associated port.

10. A method comprising:
providing a regional monitoring system which responds to various conditions in a region:
providing an audio alarm verification test unit which is associated with the monitoring system;
initiating a verification test using the test unit and wirelessly communicating with a displaced alarm forwarding system, and transmitting a selected message to the system; and
wherein the monitoring system operates independently of the test unit.

11. A method as in claim 10 which includes entering an audio test message at the test unit.

12. A method as in claim 11 which includes transmitting the test message to a test port of the alarm forwarding system.

13. A method as in claim 12 which includes returning the test message to the test unit.

14. A method as in claim 13 which includes presenting the received test message audibly at the test unit.

15. A system comprising:
a regional monitoring system with a local system control panel; and
circuitry at the monitoring system to provide alarm audio verification testing wherein the testing functions in a standalone mode relative to the monitoring system, and, wherein the tests can be implemented without causing a false alarm, and wherein test audio feedback can be provided at the system control panel.

16. A system as in claim 15 where the monitoring system communicates via a computer network with a displaced alarm forwarding system having a communications set-up port, an address providing port and a streaming audio port.

17. A system as in claim 16 wherein the monitoring station communications with the set-up port to establish an audio communications path, and wherein the alarm forwarding system communicates an initial audio message to the local system control panel, via the streaming audio port, to initiate an audio test.

18. A system as in claim 17 where the local system control panel forwards a test message, via the streaming audio port to the alarm forwarding system, and wherein the system returns the test message to the monitoring station via that port.

19. A system as in claim 18 where the monitoring station determines if the received test message is the same as the forwarded test message, and responsive thereto, audibly presents that message via the local system control panel.

20. A system as in claim 15 where the alarm forwarding system includes a multiply ported communications server.
